(19) United States
(12) Patent Application Publication
(10) Pub. No.: US 2007/0086747 A1
(43) Pub. Date: Apr. 19, 2007

(54) Reproducing apparatus and video data storing method

(75) Inventors: Hye-jeong Chun, Yongin-si (KR); Jung-wan Ko, Suwon-si (KR); Kil-soo Jung, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/581,422

(22) Filed: Oct. 17, 2006

(30) Foreign Application Priority Data
Oct. 17, 2005 (KR) 2005-97732
Nov. 17, 2005 (KR) 2005-110373
Sep. 28, 2006 (KR) 2006-95057

(51) Int. Cl. H04N 7/00

(52) U.S. Cl. 386/95

(57) ABSTRACT

A reproducing apparatus and a video data storage method, which are capable of seamlessly reproducing video data read from an additional storage medium, by providing profile information regarding a data transmission speed of the additional storage medium included in the reproducing apparatus. The reproducing apparatus includes an additional storage medium to store the video data and/or additional data required for reproducing the video data, an audio/video (AV) decoder to receive the video data from the additional storage medium, and to decode and output the video data, and a data storage manager to manage data storage in the additional storage medium, with reference to profile information on a performance of the additional storage medium.

### CROSS-REFERENCE TO RELATED PATENT APPLICATIONS

This application claims the benefits of Korean Application No. 2005-97732, filed Oct. 17, 2005, No. 2005-110373, filed Nov. 17, 2005, and No. 2006-95057, filed Sep. 28, 2006 in the Korean Intellectual Property Office, the disclosures of which are incorporated herein in their entireties by reference.

### BACKGROUND OF THE INVENTION

1. Field of the Invention

Aspects of the present invention relate to an apparatus for reproducing video data and a method of storing video data.

2. Description of the Related Art

In order to reproduce high definition video and to enhance user interactions, a reproducing apparatus for reproducing data from an information storage medium, including additional data, receives data required for reproduction from an additional storage medium included in the reproducing apparatus, as well as from a removable information storage medium, thus stably reproducing various additional data together with high definition video data.

FIG. 1 is a view for explaining a conventional reproducing apparatus 100. As shown in FIG. 1, the reproducing apparatus 100 for reproducing high definition video data and various additional data includes an additional storage medium 110. The additional storage medium 110 is included in the reproducing apparatus 100, in order to store video data and/or additional data required for reproducing high definition video. The reproducing apparatus 100 stores video data and/or additional data received through a network 120 in the additional storage medium 110. On the other hand, the reproducing apparatus 100 stores video data and/or additional data read from a disc 130 in the additional storage medium 110.

Additional data, among data stored in the additional storage medium 110 in this manner, occupies a relatively small amount of memory compared to high definition video. Accordingly, if the additional data is stored, for example, in a cache memory, etc., before reproduction and is then reproduced, the additional data may be stably reproduced without being greatly influenced by a data transmission speed of the additional storage medium 110. However, in the case of high definition video data, due to a relatively high average multiplexing rate, when a data transmission speed of the additional storage medium 110 is low, the high definition video data cannot be transmitted in time to an AV decoder of the reproducing apparatus 100, which may prevent seamless reproduction.

### SUMMARY OF THE INVENTION

An aspect of the present invention provides a reproducing apparatus, which is capable of seamlessly reproducing video data read from an additional storage medium, by providing profile information regarding a data transmission speed of the additional storage medium included in the reproducing apparatus, and a method of storing video data.

According to an aspect of the present invention, there is provided a reproducing apparatus to reproduce video data, the apparatus including: an additional storage medium storing video data and/or additional data required to reproduce the video data; an audio/video (AV) decoder to receive the video data from the additional storage medium, and to decode and output the video data; a manager to manage data storage in the additional storage medium, with reference to profile information on performance of the additional storage medium.

The reproducing apparatus further includes a register to store the profile information on the performance of the additional storage medium.

The profile information on the performance of the additional storage comprises a level to define a minimum data transmission speed.

The profile information on the performance of the additional storage medium comprises information related to a minimum performance level capable of being implemented by the reproducing apparatus, a graphics performance level, a maximum transmission rate level, an image decoding speed level, a network performance level, a network bandwidth level, a storage transmission rate level, a storage performance level, a system memory size level, and a CPU performance level.

The minimum performance level includes information to indicate whether a network, an additional storage medium, or a sub video is supported.

If a value of the minimum performance level is a first value, neither the network, the additional storage medium, nor the sub video are supported, if the value of the minimum performance level is a second value, neither the network nor the sub video are supported but the additional storage medium is supported, if the value of the minimum performance level is a third value, neither the network nor the additional storage medium are supported but the sub video is supported, if the value of the minimum performance level is a fourth value, the network, the additional storage medium, and the sub video are all supported.

The manager checks a maximum multiplexing rate of video data that is to be stored in the additional storage medium and the profile information of the additional storage medium, and stores the video data in the additional storage medium if the profile information of the additional storage medium supports the maximum multiplexing rate of the video data that is to be stored.

The manager transmits the profile information of the additional storage medium to a server, receives video data corresponding to the profile information from the server, and stores the video data in the additional storage medium.

The manager includes: a disc manager to read the video data required for reproduction from an information storage medium and to transfer the data to the AV decoder; a storage manager to store/read video data in/from the additional storage medium and to transfer the video data to the AV decoder; a network manager to transfer reproduction-related information of the reproducing apparatus to a designated server on a network, or to transfer the video data from the designated server to the storage manager or the AV decoder; and a navigation manager to control the AV decoder, the disc manager, the network manager, and the storage manager.

According to another aspect of the present invention, there is provided a method of storing video data including: checking profile information regarding performance of an additional storage medium, which stores the video data and/or additional data required for reproducing the video data; and storing the video data in the additional storage medium, according to the profile information of the additional storage medium.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view for explaining a conventional reproducing apparatus;

FIG. 2 is a block diagram of a reproducing apparatus according to an embodiment of the present invention;

FIG. 3 illustrates an example of profile information;

FIG. 4 illustrates another example of the profile information illustrated in FIG. 2;

FIG. 5 illustrates detailed information of a minimum performance level illustrated in FIG. 4;

FIG. 6 is a flowchart illustrating a method of storing video data in an additional storage medium, according to an embodiment of the present invention;

FIG. 7 is a flowchart illustrating a method of storing video data from an information storage medium in an additional storage medium, according to another embodiment of the present invention; and

FIG. 8 is a flowchart illustrating a method of storing video data from a network in an additional storage medium, according to another embodiment of the present invention.

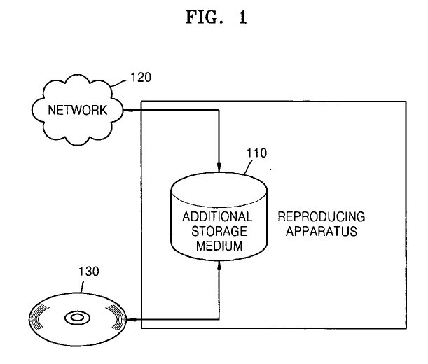

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

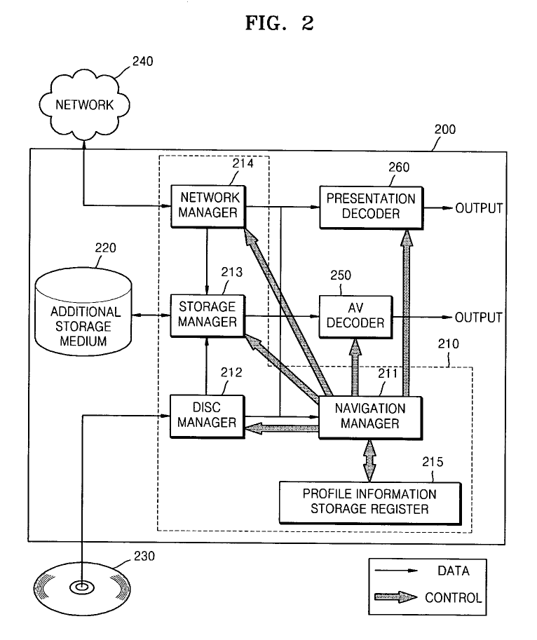

FIG. 2 is a block diagram of a reproducing apparatus 200 according to an embodiment of the present invention. As shown in FIG. 2, the reproducing apparatus 200, which reproduces video data or reproduces video data and additional data, includes a manager 210 to control and to manage all the components of the reproducing apparatus 200, an additional storage medium 220, an AV decoder 250, and a presentation decoder 260.

The additional storage medium 220 is included in the reproducing apparatus 200, in order to store video data and/or additional data required for reproducing video. The additional storage medium 220 may be a hard disc drive (HDD), a flash memory, etc. The AV decoder 250 decodes and outputs the video data. The presentation decoder 260 decodes and outputs the additional data. The manager 210 controls the AV decoder 250 and the presentation decoder 260, and manages data transmission and reception of the additional storage medium 220, a network, and the information storage medium 230. Particularly, according to an embodiment of the present invention, the manager 210 stores the video data in the additional storage medium 220, with reference to profile information of the reproducing apparatus 200 or the additional storage medium 220.

The configuration of the manager 210 will be described in detail below. With reference again to FIG. 2, the manager 210 includes a navigation manager 211, a disc manager 212, a storage manager 213, a network manager 214, and a profile information storage register 215.

The disc manager 212 reads data required for reproduction from the information storage medium (for example, an optical disc, etc.) 230, and transfers the data to respective reproduction modules. The storage manager 213 stores video data and/or additional data in the additional storage medium 220, or reads video data and/or additional data from the additional storage medium 220, and transfers them to the respective reproduction modules. The network manager 214 transmits reproduction-related information of the reproducing apparatus 200 to a designated server through a network, or transmits the video data and/or additional data received from the designated server to the storage manager 213 or the respective reproduction modules. The navigation manager 211 controls the AV decoder 250, the presentation decoder 260, the disc manager 212, the storage manager 213, and the network manager 214, according to a reproduction order of the video data and/or additional data. The profile information storage register 215 includes information regarding a data transmission speed of the additional storage medium 220 included in the reproducing apparatus 200.

Video data that is to be reproduced by the reproducing apparatus 200 may be classified into Standard Definition (SD) and High Definition (HD) data, according to a resolution of the video data. In the case of SD DVDs, video data is multiplexed at a maximum multiplexing rate of 10.08 Mbps, and in the case of HD DVDs, video data is multiplexed at a multiplexing rate that is higher than 10.08 Mbps.

Meanwhile, the additional storage medium 220 provides for various transmission speeds according to the type of address storage medium 220 being used. For example, in the case of storage media such as hard discs, an ATA122 device, which is widely used, has a maximum data transmission speed of 133 MB/s, and a Serial-ATA device has a maximum data transmission speed of 150 MB/s. Meanwhile, flash memories have a data transmission speed of approximately 10 MB/s. When SD video data is read for reproduction, both a hard disc and a flash memory may transmit the SD video data so that underflow is not generated in the AV decoder 250. However, in the case of HD video, a hard disc may transmit the HD video data to the AV decoder 250 without causing underflow, while a flash memory cannot transmit the HD video data stably to the AV decoder 250 and seamless reproduction is not guaranteed.

Accordingly, an aspect of the present invention is to limit video data that is to be stored in the additional storage medium 220, according to a data transmission speed of the additional storage medium 220. The reproducing apparatus 200, as illustrated in FIG. 2, stores information according to the data transmission speed of the additional storage medium 220 in the profile information storage register 215. When video data must be stored in the additional storage medium 220, the navigation manager 211 determines whether the video data is already stored, with reference to the profile information of the additional storage medium 220 that is stored in the profile information storage register 215. The profile information according to the data transmission speed of the additional storage medium 220 may be stored in any other storage devices besides system registers 215.

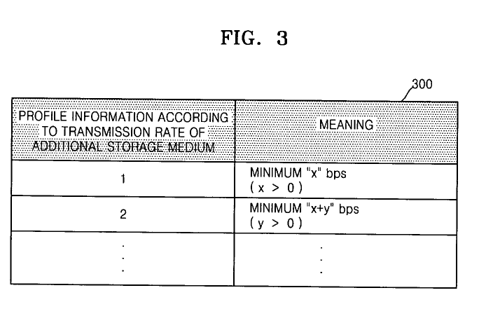

FIG. 3 illustrates an example of profile information 300. As illustrated in FIG. 3, profile information 300 according to a data transmission speed of an additional storage medium may be defined as various profiles according to a predetermined minimum data transmission speed, wherein unique profile values are assigned to respective reproducing apparatuses. As shown in FIG. 3, a transmission speed of minimum “x” bps is defined as “1,” and a transmission speed of minimum “x+y” bps is defined as “2.” The profile information 300 illustrated in FIG. 3 is, of course, only an example and it is understood that the profile information 300 may be provided in various formats according to the data transmission speed of the additional storage medium.

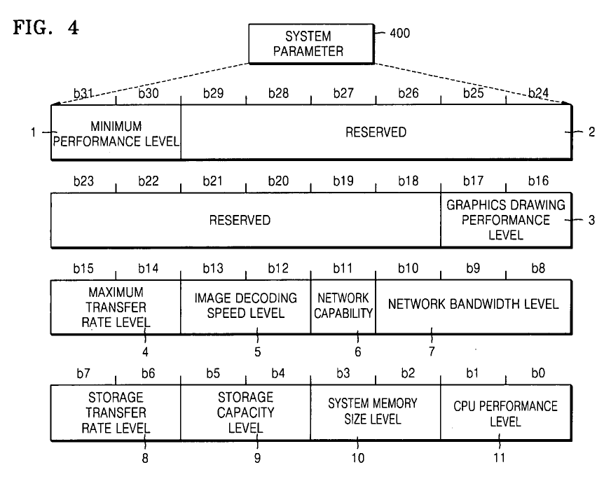

FIG. 4 illustrates another example of profile information, wherein a system parameter 400, which stores profile information ensuring minimum values of respective items, is defined. As shown in FIG. 4, the system parameter 400 comprises 32 bits, and includes sections such as a minimum performance level 1, a reserved section 2, a graphics drawing performance level 3, a maximum transfer rate level 4, a image decoding speed level 5, a network capability 6, a network bandwidth level 7, a storage transfer rate level 8, a storage capacity level 9, a system memory size level 10, and a CPU performance level 11.

The CPU performance level 11 indicates an operating speed of a main processor to interpret program-based data included in an information storage medium. The system memory size level 10 indicates the size of a task area to allow for a reading and a driving of program-based data included in the information storage medium and an additional storage medium (i.e., the information storage medium 230 and the additional storage medium 220 of FIG. 2). The storage performance level 9 indicates the size of the additional storage medium. The storage transfer rate level 8 indicates information according to a data transmission speed of the additional storage medium, for example, the profile information 300 illustrated in FIG. 3. The network capability 6 and the network bandwidth level 7 respectively indicate whether a network is available and a data transmission rate for network communication when the network is available. The image decoding speed level 5 indicates a time that is required for a decoding of an image (JPEG, PNG, GIF) referred to by the program-based data. The maximum transfer rate level 4 indicates an amount of data read per second from an information storage medium. The graphics drawing performance level 3 indicates an operating speed at which a graphics task is performed using the program-based data. The reserved section 2 is a field for future use. The minimum performance level 1 represents a representative value indicating performance, which may be implemented by a reproducing apparatus by combinations of performance factors of the reproducing apparatus.

The above-described items are used to classify the performance of the reproducing apparatus, together with a data transmission speed of the additional storage medium. The above-described items also provide a guideline to produce contents that are enhanced in view of user interaction characteristics to content producers. Further, the above-described items inform users of picture quality of content included in an information storage medium and, further, inform the users of whether the content must be reproduced when AV data in the information storage medium is reproduced using the corresponding reproducing apparatus.

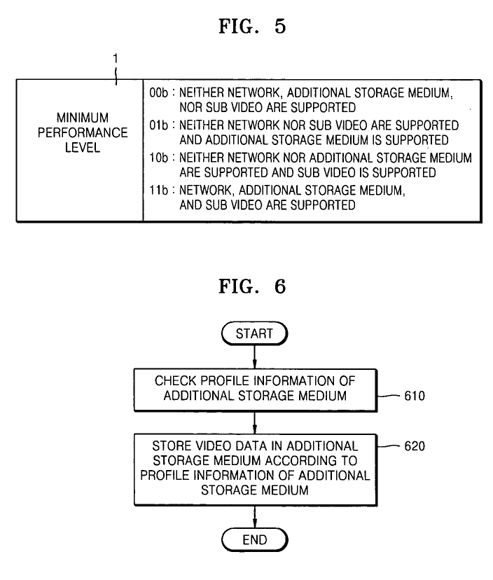

FIG. 5 illustrates detailed information of the minimum performance level 1 illustrated in FIG. 4. The minimum performance level 1 provides information on whether a network is supported, whether an additional storage media is supported, and whether sub video is supported. Whether sub video is supported represents whether a decoder to decode the sub video exists. That is, if the decoder to decode the sub video does not exist, even if the reproducing apparatus stores the sub video in the additional storage medium, the sub video stored in the additional storage medium cannot be reproduced. Thus, the reproducing apparatus refers to the information on whether the sub video is supported, and only in the case where the sub video is supported is the reproducing apparatus able to store the sub video in the additional storage medium.

As shown in FIG. 5, if the minimum performance level 1 is ‘00b’, this indicates that none of a network, an additional storage medium, and a sub video is supported. If the minimum performance level 1 is ‘01b’, this indicates that, while a network and a sub video are not supported, an additional storage medium is supported. If the minimum performance level 1 is ‘10b’, this indicates that, while a network and an additional storage medium is supported, a sub video is supported. If the minimum performance level is ‘11b’, this indicates that a network, an additional storage medium, and a sub video are supported. Accordingly, by defining the minimum performance level 1 illustrated in FIG. 5, it is possible to recognize performance, which can be implemented by a reproducing apparatus, by using the minimum performance level 1, without checking detailed level values of the respective items of the system parameter 400 (see FIG. 4).

FIG. 6 is a flowchart illustrating a method of storing video data in the additional storage medium 220, according to an embodiment of the present invention. As shown in FIGS. 2 and 6, when video data is stored in the additional storage medium 220, the manager 210 checks profile information of the additional storage medium 220 (operation 610). Then, the manager 210 stores the video data in the additional storage medium 220, according to the profile information of the additional storage medium 220 (operation 620).

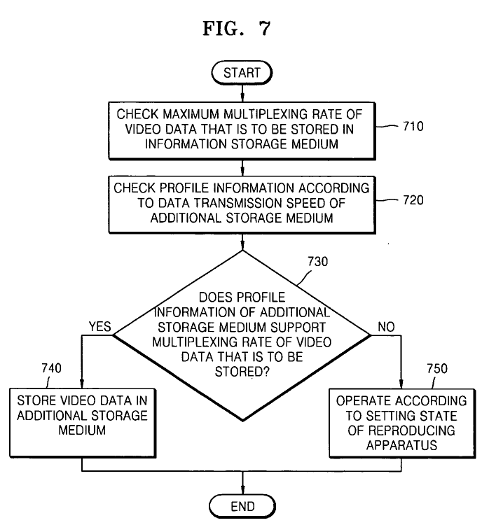

FIG. 7 is a flowchart illustrating a method of storing video data from an information storage medium in the additional storage medium 220, which is a specific example of the embodiment of FIG. 6. As shown in FIGS. 2 and 7, when video data is stored in the additional storage medium 220, the navigation manager 211 checks a maximum multiplexing rate of video data that is to be stored in the additional storage medium 220, using attribute information of the video data (operation 710). Also, the navigation manager 211 checks profile information according to a data transmission speed of the additional storage medium 220, by using the profile information storage register 215 (operation 720).

Then, the navigation manager 211 determines whether the profile information of the additional storage medium 220 supports a multiplexing rate of the video data that is to be stored (operation 730). That is, the navigation manager 211 checks whether an underflow will be generated in an AV decoder when data that is to be currently stored is reproduced later.

If the profile information of the additional storage medium 220 supports the multiplexing rate of the video data that is to be stored, that is, if the video data may be read at a data transmission speed of current profile information, the navigation manager 211 controls the storage manager 213 and the disc manager 212 so that the video data is stored in the additional storage medium 220 (operation 740). In other words, the disc manager 212 reads the video data from the information storage medium 230, and transfers the video data to the storage manager 213. The storage manager 213 then stores the video data in the additional storage medium 220.

Meanwhile, if the profile information of the additional storage medium 213 does not support a multiplexing rate of the video data that is to be stored, the navigation manager 211 operates according to a setting state of the reproducing apparatus (operation 750). In other words, if a data transmission speed of the additional storage medium 220 cannot ensure a seamless reproduction of video data that is to be stored, the navigation manager 211 outputs a warning message or the video data is stored regardless of data transmission speeds according to respective reproducing apparatuses.

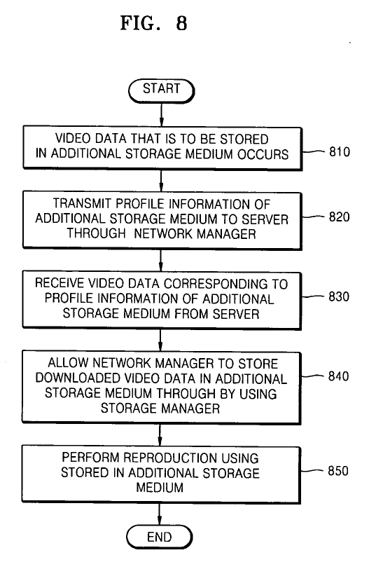

FIG. 8 is a flowchart illustrating a method of storing video data from a network in the additional storage medium 220, which is another specific example of the embodiment of FIG. 6. As shown in FIGS. 2 and 8, if video data that is to be stored in the additional storage medium 220 is downloaded from a network, that is, if video data that is to be stored in the additional storage medium 220 is generated automatically or by a request of a user during reproduction (operation 810), the navigation manager 211 controls the network manager 214 to transfer data transmission speed profile information of the additional storage medium 220 to a server (operation 820). At this time, server authentication information to allow for authentication and route information of video data that is to be downloaded may be further transmitted.

Then, the reproducing apparatus 200 receives video data that has a proper multiplexing rate from a server, with reference to profile information of the additional storage medium 220 (operations 830). That is, a server may provide video data of various resolutions considering a network bandwidth of a client, with reference to profile information of the additional storage medium 220.

The network manager 214 then stores the downloaded video data in the additional storage medium 220 using the storage manager 213 (operation 840).

Lastly, the reproducing apparatus 200 performs a reproduction using the video data stored in the additional storage medium 220 (operation 850).

The reproducing method may also be embodied as computer readable codes on a computer readable recording medium. The computer readable recording medium is any data storage device that stores data which may be thereafter read by a computer system. Examples of the computer readable recording medium include read-only memory (ROM), random-access memory (RAM), CD-ROMs, magnetic tapes, floppy disks, optical data storage devices, and signals embedded as carrier waves (such as data transmission through the Internet). The computer readable recording medium may also be distributed over network coupled computer systems so that the computer readable code is stored and executed in a distributed fashion. Also, functional programs, codes, and code segments for accomplishing the present invention may be easily construed by programmers skilled in the art to which the present invention pertains.

In a reproducing apparatus according to aspects of the present invention, when video data is read from an additional storage medium and only the video data or both the video data and additional data are reproduced, seamless reproduction can be ensured.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A reproducing apparatus to reproduce video data, the apparatus comprising:
an additional storage medium to store the video data and/or additional data required for reproducing the video data;
an audio/video (AV) decoder to receive the video data from the additional storage medium, and to decode and output the video data; and
a manager to manage data storage in the additional storage medium, with reference to profile information on a performance of the additional storage medium.

2. The reproducing apparatus according to claim 1, further comprising a register to store the profile information on the performance of the additional storage medium.

3. The reproducing apparatus according to claim 1, wherein the profile information on the performance of the additional storage comprises a level to define a minimum data transmission speed.

4. The reproducing apparatus according to claim 1, wherein the profile information on the performance of the additional storage medium includes at least one of information related to a minimum performance level capable of being implemented by the reproducing apparatus, a graphics performance level, a maximum transmission rate level, an image decoding speed level, a network performance level, a network bandwidth level, a storage transmission rate level, a storage performance level, a system memory size level, and/or a CPU performance level.

5. The reproducing apparatus according to claim 1, wherein the minimum performance level includes information indicating whether a network, an additional storage medium, or a sub video is supported.

6. The reproducing apparatus according to claim 5, wherein, if a value of the minimum performance level is a first value, neither the network, the additional storage medium, nor the sub video are supported, if the value of the minimum performance level is a second value, neither the network nor the sub video are supported but the additional storage medium is supported, if the value of the minimum performance level is a third value, neither the network nor the additional storage medium are supported but the sub video is supported, if the value of the minimum performance level is a fourth value, the network, the additional storage medium, and the sub video are all supported.

7. The reproducing apparatus according to claim 1, wherein the manager checks a maximum multiplexing rate of video data that is to be stored in the additional storage medium and the profile information of the additional storage medium, and stores the video data in the additional storage medium if the profile information of the additional storage medium supports the maximum multiplexing rate of the video data that is to be stored.

8. The reproducing apparatus according to claim 1, wherein the manager transmits the profile information of the additional storage medium to a server, receives video data corresponding to the profile information from the sever, and stores the video data in the additional storage medium.

9. The reproducing apparatus according to claim 1, wherein the manager comprises:
a disc manager to read video data that is required for reproduction from an information storage medium and to transfer the data to the AV decoder;
a storage manager to store/read video data in/from the additional storage medium and to transfer the video data to the AV decoder;
a network manager to transfer reproduction-related information of the reproducing apparatus to a designated server on a network, or to transfer the video data from the designated server to the storage manager or the AV decoder; and
a navigation manager to control the AV decoder, the disc manager, the network manager, and the storage manager.

10. A method of storing video data comprising:
checking profile information regarding performance of an additional storage medium, which stores the video data and/or additional data required for reproducing the video data; and
storing the video data in the additional storage medium, according to the profile information of the additional storage medium.

11. The method according to claim 10, further comprising reading the profile information regarding the performance of the additional storage medium from a system register.

12. The method according to claim 10, wherein the profile information on the performance of the additional storage medium comprises a level to define a minimum data transmission speed.

13. The method according to claim 10, wherein the profile information on the performance of the additional storage medium includes at least one of information related to a minimum performance level capable of being implemented by the reproducing apparatus, a graphics performance level, a maximum transmission rate level, an image decoding speed level, a network performance level, a network bandwidth level, a storage transmission rate level, a storage performance level, a system memory size level, and/or a CPU performance level.

14. The method according to claim 13, wherein the minimum performance level includes information to indicate whether a network, an additional storage medium, or a sub video is supported.

15. The method according to claim 14, wherein, if a value of the minimum performance level is a first value, neither the network, the additional storage medium, nor the sub video are supported, if the value of the minimum performance level is a second value, neither network nor the sub video are supported but the additional storage medium is supported, if the value of the minimum performance level is a third value, neither the network nor the additional storage medium are supported but the sub video is supported, if the value of the minimum performance level is a fourth value the network, the additional storage medium, and the sub video are all supported.

16. The method according to claim 14, wherein the checking comprises:
checking a maximum multiplexing rate of video data that is to be stored in the additional storage medium and profile information of the additional storage medium; and
if the profile information of the additional storage medium supports the maximum multiplexing rate of the video data that is to be stored, storing the video data in the additional storage medium.

17. The method according to claim 10, wherein the checking comprises:
transmitting the profile information of the additional storage medium to a server through a network; and
receiving video data corresponding to the profile information from the server.

18. A reproducing apparatus to store video data for reproduction, the apparatus comprising:
an additional storage medium to store the video data and/or additional data required for reproducing the video data; and
a data storage manager to compare a maximum multiplexing rate of the video data with profile information of the additional storage medium, and to store the video data in the additional storage medium if the profile information of the additional storage medium supports the maximum multiplexing of the video data.

19. A computer readable medium having a program stored therein to determine if video data to be reproduced by a reproducing apparatus should be stored in an additional storage medium of the reproducing apparatus by comparing a maximum multiplexing rate of the video data with profile information of the additional storage medium, and to store the video data in the additional storage medium if the profile information of the additional storage medium supports the maximum multiplexing of the video data.

20. A method of storing video data in an additional storage medium of a reproducing apparatus, which stores video data and/or additional data required for reproducing the video data, the method comprising:
comparing a maximum multiplexing rate of the video data with profile information of the additional storage medium; and
storing the video data in the additional storage medium, if the profile information of the additional storage medium supports the maximum multiplexing of the video data.
